(19) United States
(12) Patent Application Publication
(10) Pub. No.: US 2010/0332023 A1
(43) Pub. Date: Dec. 30, 2010

(54) INTEGRATED ELECTRONIC PILLBOX

(75) Inventors: Pradeep R. Tripathi, Miami Beach, FL (US); Abhinav K. Gautam, Miami Beach, FL (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Nexus Clinical, LLC, Miami Beach, FL (US)

(21) Appl. No.: 12/822,456

(22) Filed: Jun. 24, 2010

Related U.S. Application Data
(60) Provisional application No. 61/219,820, filed on Jun. 24, 2009.

(51) Int. Cl. G06F 17/00; B65D 83/04; E05B 65/52; E05B 47/00; G08B 21/00

(52) U.S. Cl. 700/231; 221/92; 221/1; 340/687

(57) ABSTRACT

A medicine dispenser and method of reminding a user to take medicine includes providing a device having a housing defining a plurality of compartment openings, each adapted to hold at least one medicine item and a plurality of covers. Each of the covers selectively closes one of the compartment openings to restrain access to the content of that compartment and provide access to the content of the respective compartment when opened. The device further includes a safety latch having first and second positions, wherein the safety latch inhibits opening of any of the covers when in its first position and allows opening of any of the covers when in its second position. When a user is reminded to take a medication, the position of the safety latch is monitored for an indication that the safety latch is moved from its first position to its second position. The user continues to receive the reminder until such indication is given.

### CROSS REFERENCE TO RELATED APPLICATION

This application claims priority from U.S. provisional patent application Ser. No. 61/219,820, filed on Jun. 24, 2009, the disclosure of which is hereby incorporated herein by reference in its entirety.

### BACKGROUND OF THE INVENTION

The present invention is directed to a medicine dispenser and method of reminding a user to take medicine and, in particular, to such dispenser and method that provides verification that the medicine has likely been taken.

The United States annually spends more than 200 billion dollars on prescription drugs per year. Studies conducted by the National Pharmaceutical Council and the American Hospital Association reveal:

1. More than 125,000 Americans die each year due to the prescription medication noncompliance, twice the number killed in automobile accidents.

2. Every day, prescription noncompliance costs more than 270 million dollars in additional hospitalization and other medical costs.

3. Nine out of every ten outpatients are taking prescribed medicines improperly, contributing to prolonged or additional illness.

4. People who miss doses need three times as many doctor visits as others and face increased medical costs.

5. Almost 60% of the prescription medication noncompliance problems could be prevented by improving compliance.

6. Ten percent (10%) of all hospital admissions are the result of prescription medication noncompliance.

7. Twenty three percent (23%) of all nursing home admissions are due to failure to take medications accurately.

8. At any given time, regardless of age group, it is estimated that up to 59% of those on five or more medications are in noncompliance.

With the burgeoning cost of the American healthcare system, it is clear that improving medication compliance could not only save lives, but it could reduce healthcare costs by billions of dollars.

### BRIEF DESCRIPTION OF THE DRAWINGS

FIG. 1 is a block diagram of a medicine dispenser according to an embodiment of the invention;

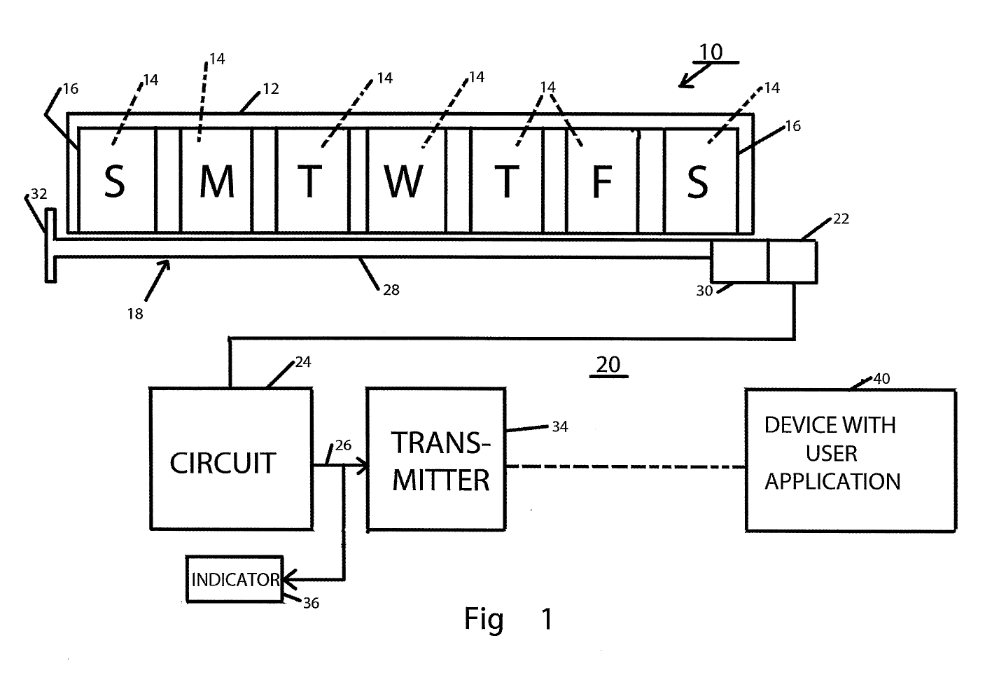

FIG. 2 is the same view as FIG. 1 of an alternative embodiment thereof; and

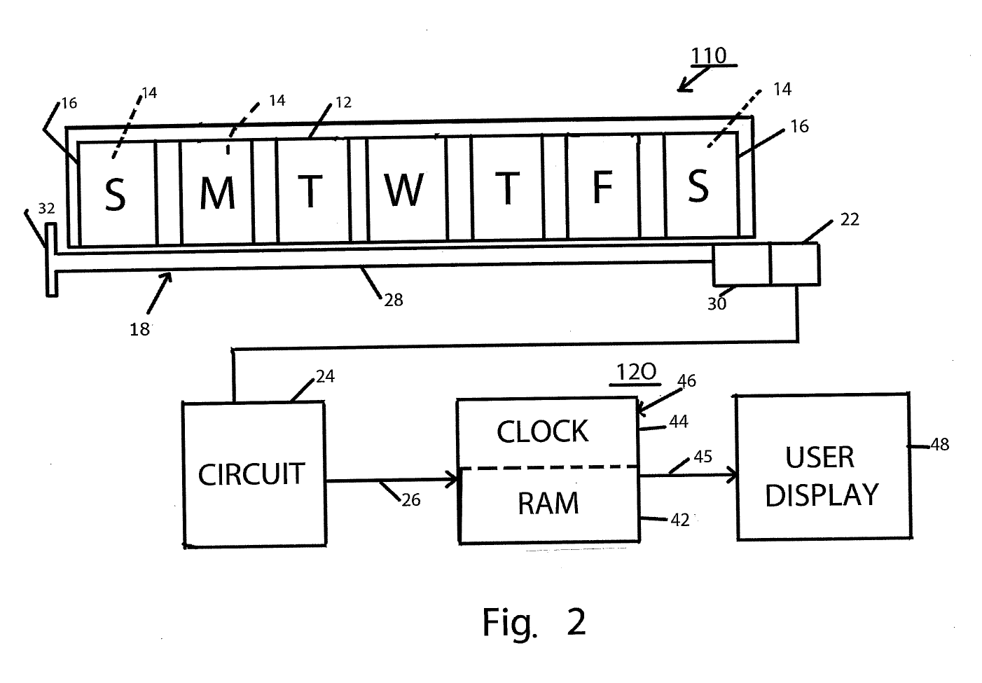

FIG. 3 is a flowchart of a method of reminding a user to take medication according to an embodiment of the invention.

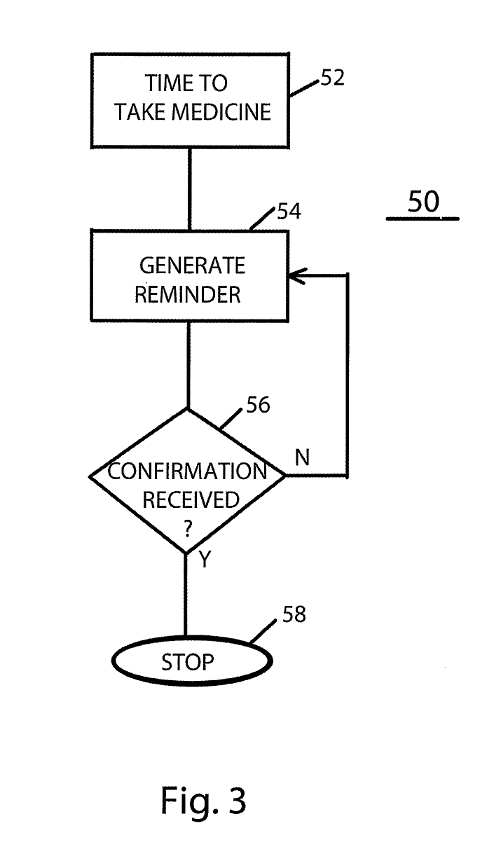

### DESCRIPTION OF THE PREFERRED EMBODIMENT

Referring now to the drawings and the illustrative embodiments depicted therein, a medicine dispenser 10 includes a housing 12 defining a plurality of compartment openings 14. Each opening 14 is configured to hold at least one medicine item, such as a pill, or the like. It is common to hold an entire day's worth of medicine items so that the compartment is accessed once a day. Dispenser 10 further includes a plurality of covers 16. Each of the covers selectively closes one of compartment openings 14 to restrain access to the content of that compartment. Each of covers 16 provides access to the content of the respective compartment when opened. Dispenser 10 further includes a safety latch 18. Safety latch 18 has first and second positions. When safety latch 18 is in the first position, it inhibits opening of any of covers 16. When safety latch 18 is manually moved to a second position by a user, it allows opening of any of covers 16. Such dispenser, as described above, has long been known in the art and is disclosed, by way of example, in any of U.S. Pat. Nos. 5,379,899; 6,000,546 and 7,494,012, the disclosures of which are hereby collectively incorporated herein by reference.

Dispenser 10 further includes a monitoring system 20 for monitoring the position of safety latch 18 and indicating when the safety latch is moved from its first position to its second position. Monitoring system 20 may include a switch 22 and a circuit 24. Switch 22 is responsive to safety latch 18. Switch 22 is in a first state when safety latch 18 is in its first position and is in a second state when the safety latch is in its second position. Circuit 24 is responsive to switch 24 and produces an output at 26 indicating that switch 22 has changed from its first state to its second state. In the illustrated embodiment, compartment openings 14 are arranged in a row and safety latch 18 is made up of an elongated member 28 that extends along the row of compartment openings. Elongated member 28 moves in a longitudinal direction, namely, along its axis of elongation, between its first and second positions. Dispenser 10 further including a biasing member, generally shown at 30 that biases elongated member 28 toward its first position.

Switch 22 may incorporate biasing member 30 such that the biasing member biases switch 22 toward its first state. This would allow the biasing member to indirectly bias the elongated member via the interaction between the elongated member and the switch. Alternatively, biasing member 30 may directly bias elongated member 28 toward said first position independent of the switch. Safety latch 18 may include a manual actuator 32 at one end portion of said elongated member that is actuatable to move elongated member 18 between its first and second positions. This allows the user to access any one (or more) of compartment openings 14. Switch 22 may be positioned at an end portion of the elongated member that is opposite actuator 32, may be positioned adjacent actuator 32, or at some location in between. Switch 22 may take any known form, such as a set of mechanical contacts, a magnetic actuated switch, a capacitive actuated switch, or the like.

Monitoring system 20 may include a transmitter 34 that is responsive to circuit 24 to transmit a signal indicating that output 26 had changes from its first state to its second state, indicating that a user has actuated safety latch 18. Transmitter 34 may be a Bluetooth transmitter, a Wi-Fi transmitter, a cellular phone transmitter, or other form of wireless transmitter, including an infrared transmitter, or the like. A user device with user application 40 may be provided that is separate from the medical dispenser and interconnected thereto by a wireless communication channel shown in phantom. The user application may reside on a separate computer-based system, such as a smart phone, a personal digital assistant, a personal computer, or the like. User application 40 repeatedly provides reminders to a user to take a medication until receiving an indication from monitoring system 20 that safety latch 18 has been moved from its first position to its second position. Such an indication may be transmitted by transmitter 34. However, user application 40 may alternatively provide reminders by e-mail, SMS text, audible signal, phone call, and the like. Once such indication is received, then user application 46 may discontinue reminders. This allows the user to discontinue the reminders by actually taking the medication rather than utilizing a snooze function often accompanying known user applications.

User application 40 may further include a pharmacological database of prescribed drugs, including images of pills or tablets, including color scheme for the pills or tablets. This database enables the system to send an image of the agent to take along with the reminder. This is particularly useful when a patient is taking multiple medications with different ingestion schedules. Also, the user device with user application 40 may include a camera, other barcode scanner, or other code-reading device that allows the user to scan the drug label and capture the drug code for sending to the user application. This facilitates the input of medications and ingestion instructions into the system.

Monitoring system 20 may include an indicator 36 that is responsive to circuit 24 to indicate that output 26 changing from its first state to its second state to provide feedback to the user that the system has registered actuation of safety latch 118. Indicator 36 may be in the form of an audible, such as a beeper, buzzer, or the like, and/or a visual indicator, such as an LED, or the like.

A dispenser 110 having a monitor system 120 may be provided that includes a reminder device 46 to provide a reminder to the user to take a medication. Reminder 46 may take the form of a memory device 42, such as a non-volatile RAM to store reminder times and related information and a clock circuit 44 to provide awareness to circuit 24 of the date and time. Of course, memory 42 and clock 44 may be incorporated into circuit 24. Reminder 46 provides an output 45 that is displayed on a user display 48 and receives output 26 from circuit 24 that indicates that safety latch 18 has been actuated. This allows a medicine dispenser 210 to be provided that includes a self-contained reminder system. Dispenser 10, 110 may include an electronic locking device that may be operated by circuit 24 to send a wireless signal to allow the covers to be opened at the same time the reminder is sent to the user. This feature enhances safety by inhibiting erroneous ingestion of medication when it is not due.

Thus, it is seen that various embodiments disclosed herein provide a method of reminding a user to take medicine by providing a device having a housing defining a plurality of compartment openings, each adapted to hold at least one medicine item and a plurality of covers, each of the covers selectively closing one of the compartments to restrain access to the content of that compartment. Each of the covers provides access to the content of the respective compartment when opened. A safety latch has first and second positions and inhibits opening of any of the covers when in the first position and allows opening of any of the covers when in said second position. According to a method 50, reminders are provided to a user (54) at a particular time (52) to take a medication. The position of the safety latch is monitored and an indication provided when the safety latch is moved from its first position to its second position indicating that the user has actuated the safety latch (56). If the confirmation is received at 56, then no further reminders are generated (55). The reminder is repeated (54) until it is determined at 56 that the indication is received at which time the reminding ceases. This allows an indication that the user has accessed the dispenser without requiring instrumentation of all of the covers for all of the compartment openings. Thus, a low cost system is provided that provides sufficient information to discontinue reminders and thereby improves the utility of the reminders because they will be discontinued by actually accessing the medicine storing compartment rather than repeatedly causing the user application to snooze.

Changes and modifications in the specifically described embodiments can be carried out without departing from the principles of the invention which is intended to be limited only by the scope of the appended claims, as interpreted according to the principles of patent law including the doctrine of equivalents.

1. A medicine dispenser, comprising:
a housing defining a plurality of compartment openings, each adapted to hold at least one medicine item;
a plurality of covers, each of said covers selectively closing one of said compartment openings to restrain access to the content of that compartment, wherein said covers provide access to the content of the respective compartment when opened;
a safety latch, said safety latch having first and second positions, wherein said safety latch inhibits opening of any of said covers when in said first position and allows opening of any of said covers when in said second position, said safety latch; and
a monitoring system, said monitoring system monitoring position of said safety latch and indicating when said safety latch is moved from said first position to said second position.

2. The dispenser as claimed in claim 1 wherein said monitoring system comprises a switch and a circuit, said switch being responsive to said safety latch wherein said switch is in a first state when said safety latch is in said first position and said switch is in a second state when said safety latch is in said second position, said circuit being responsive to said switch to produce an output indicating said switch changing from said first state to said second state.

3. The dispenser as claimed in claim 2 wherein said compartments are arranged in a row and wherein said safety latch comprises an elongated member extending along the row of compartments, and further wherein said safety latch comprises an elongated member that extends substantially the length of said row.

4. The dispenser as claimed in claim 3 wherein said elongated member moves in a longitudinal direction between said first and second positions and said dispenser further including a biasing member biasing said elongated member toward said first position.

5. The dispenser as claimed in claim 4 wherein said switch includes said biasing member and said biasing member biases said switch toward said first state.

6. The dispenser as claimed in claim 4 wherein said biasing member directly biases said elongated member toward said first position.

7. The dispenser as claimed in claim 3 wherein said safety latch includes a manual actuator at one end portion of said elongated member that is actuatable to move said elongated member between said first and second positions.

8. The dispenser as claimed in claim 7 wherein said switch is positioned at an end portion of said elongated member that is opposite said one end portion.

9. The dispenser as claimed in claim 7 wherein said switch is positioned at said one end portion of said elongated member.

10. The dispenser as claimed in claim 9 wherein said switch comprises one chosen from a set of mechanical contacts, a magnetic actuated switch and a capacitive actuated switch.

11. The dispenser as claimed in claim 2 wherein said monitoring system comprises a transmitter that is responsive to said circuit to transmit a signal indicating said output changing from said first state to said second state.

12. The dispenser as claimed in claim 11 wherein said transmitter comprises at least one chosen from a Bluetooth transmitter, a Wi-Fi transmitter or a cellular phone transmitter.

13. The dispenser as claimed in claim 2 wherein said monitoring system comprises a an indicator responsive to said circuit to indicate said output changing from said first state to said second state.

14. The dispenser as claimed in claim 13 wherein said indicator comprises at least one chosen from an audible indicator and a visual indicator.

15. The dispenser as claimed in claim 2 wherein said monitor includes a reminder device, said reminder device providing a reminder to take a medication.

16. The dispenser as claimed in claim 15 wherein said reminder comprises a memory and a clock.

17. The dispenser as claimed in claim 1 in combination with a user computer software application, said application repeatedly providing reminders to a user to take a medication until receiving an indication from said monitoring system that said safety latch has been moved from said first position to said second position.

18. The dispenser as claimed in claim 17 wherein said user application includes a database of medication images for display of images of a medication to be taken by the user.

19. The dispenser as claimed in claim 1 including an electronic locking device, said electronic locking device being selectively operable by said monitoring system to allow a user to open said covers.

20. A method of reminding a user to take medicine, said method comprising:
providing a device comprising a housing defining a plurality of compartment openings, each adapted to hold at least one medicine item and a plurality of covers, each of said covers selectively closing one of said compartment openings to restrain access to the content of that compartment, wherein each of said covers provide access to the content of the respective compartment when opened, said device further comprising a safety latch, said safety latch having first and second positions, wherein said safety latch inhibits opening of any of said covers when in said first position and allows opening of any of said covers when in said second position;
reminding a user at a time to take a medication; and
monitoring the position of said safety latch and indicating when said safety latch is moved from said first position to said second position and repeating said reminding until said indicating occurs.
